(19) United States
(12) Patent Application Publication
(10) Pub. No.: US 2007/0185422 A1
(43) Pub. Date: Aug. 9, 2007

(54) Sound message system

(76) Inventors: James George Nieuwoudt, Bloemfontein (ZA); John Anthony Davis, Bloemfontein (ZA); Martinus Postma Voster, Pretoria (ZA); Karin Eloise Burger, Pretoria (ZA); Johannes Christiaan Raaths, Silkaatsnek (ZA)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/556,557

(22) PCT Filed: May 13, 2004
(86) PCT No.: PCT/IB04/50682

§ 371 Date: Apr. 2, 2007

(30) Foreign Application Priority Data
May 13, 2003 (ZA) 2003/3646
Nov. 28, 2003 (ZA) 2003/9291

(51) Int. Cl. A61H 7/00

(52) U.S. Cl. 601/148

(57) ABSTRACT

Apparatus (10,12) for relieving pain in a mammal comprises a generator (32, 40, 22) for an audible signal having a level at a source (22) of the signal of smaller than 100 dBA and having a frequency of between 50 Hz and 1000 Hz. An applicator (12) for applying the audible signal to the body of the mammal is also provided.

### TECHNICAL FIELD

This invention relates to apparatus for relieving pain in a mammal.

Various apparatus for use in relieving pain in human patients are known in the art. Some of the known apparatus generate electrical signals which, in use, are applied via suitable electrodes to the body of the patient to be treated. The signals often cause discomfort or pain and in some cases may even cause bum marks on the skin of the patient. Other known apparatus are too cumbersome and even too complex to use by the user himself. Still other known and available apparatus are too expensive.

### OBJECT OF THE INVENTION

Accordingly it is an object of the present invention to provide an alternative apparatus for relieving pain with which the applicant believes the aforementioned disadvantages may at least be alleviated.

### SUMMARY OF THE INVENTION

According to the invention there is provided apparatus for relieving pain in a body of a mammal, the apparatus comprising:
a generator for an audible signal having a level at a source of the signal of smaller than 100 dBA and having a frequency between 50 Hz and 1000 Hz; and
an applicator for applying the audible signal to the body of the mammal.

The level is preferably between 50 dBA and 80 dBA, and more preferably between 60 dBA and 70 dBA. The frequency is preferably between 70 Hz and 160 Hz. In some embodiments the audible signals may be entrained in accompanying music.

The generator may comprise an electrical signal generator and a sound transducer. The sound transducer may comprise a suitable loudspeaker, such as a diaphragm loudspeaker.

The electrical signal may have any suitable waveform. It may have a sinusoidal waveform. In other embodiments it may have a square, triangular or saw-tooth waveform. Hence the waveform may be continuous, but in other embodiments it may be in the form of a train of equi- or randomly spaced pulses.

The electrical signal generator may be housed in a main housing and the applicator may comprise a separate housing for the transducer and which is connectable to the main housing by a suitable link. In other embodiments the electrical signal generator and transducer may both be located in a common hand held housing.

The transducer may be located in a peripheral region of the applicator, so that, in use, it can be held in very close proximity to or substantially against the skin of the patient. In other embodiments there may be a bell, frusta conical or other shaped spacer between the transducer and an outlet port for the audible signal.

In still another embodiment the electrical signal generator may comprise a computing device such as a personal computer in the form of a desk top computer, a lap top computer a palm device or any other computing device. The device may hence be connectable to other devices via any suitable data network, such as the Internet. Data relating to the electrical signal to be generated may be downloaded into the computing device via the network. A website with treatment data and other information may also be provided.

In yet another embodiment, the electrical signal generator may form part of a decoder for receiving encoded broadcast services, such as encoded television services. In this embodiment data relating to the signals to be generated may be transmitted to the decoder from a head end via satellite, for example.

In still another embodiment the generator may be Integrated in a cellular phone. In this embodiment data relating to the signals to be generated may be downloaded into a memory arrangement of the cellular phone, via the cellular phone infrastructure.

The applicator may also be made available to passengers in an airliner.

The applicator may be connectable to the known console with control panel for sound and cinematograph services at each seat in the plane.

In still other embodiments, the applicator may be integrated in a wristwatch.

### BRIEF DESCRIPTION OF THE ACCOMPANYING DIAGRAMS

The invention will now further be described, by way of example only, with reference to the accompanying diagrams wherein

FIG. 1 is a front view of a control panel of a signal generator of the apparatus according to the invention;

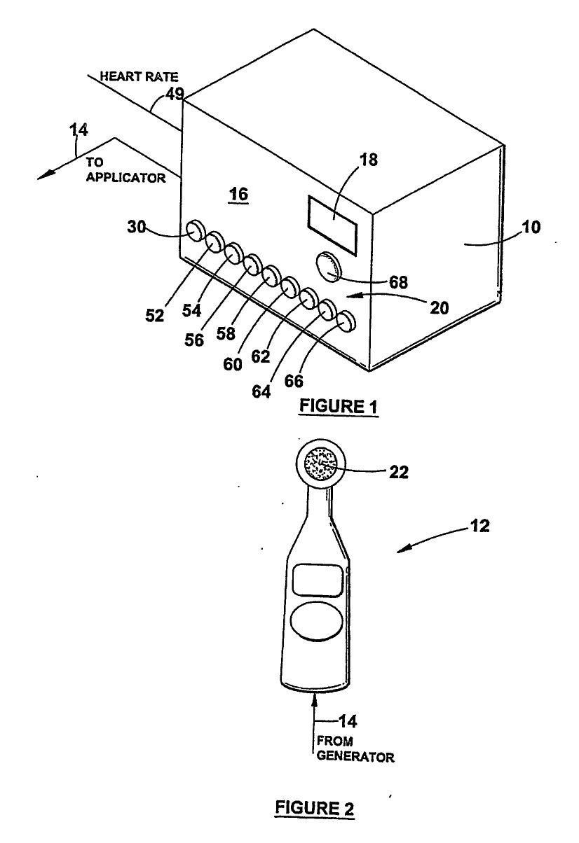

FIG. 2 Is a diagrammatic representation of a sound wave applicator forming part of the apparatus;

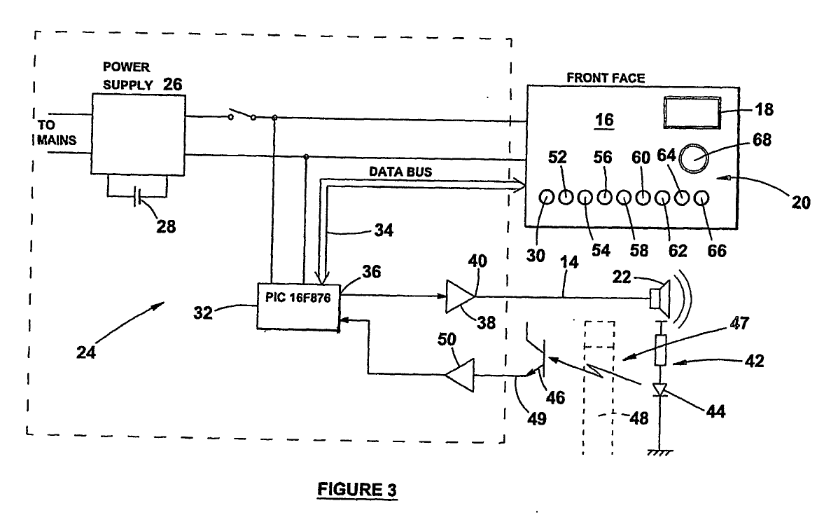

FIG. 3 Is a block diagram of electronic circuitry of the apparatus;

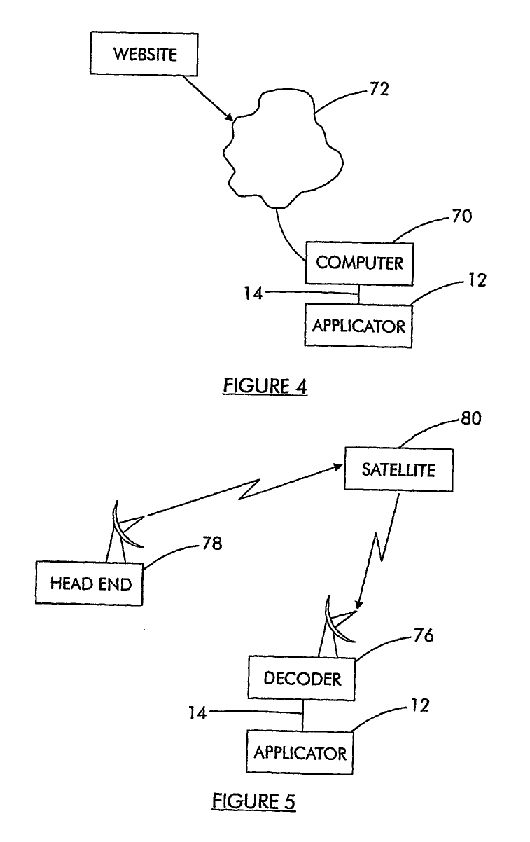

FIG. 4 is a block diagram of a second embodiment of the apparatus according to the invention;

FIG. 5 Is a block diagram of a third embodiment of the apparatus according to invention;

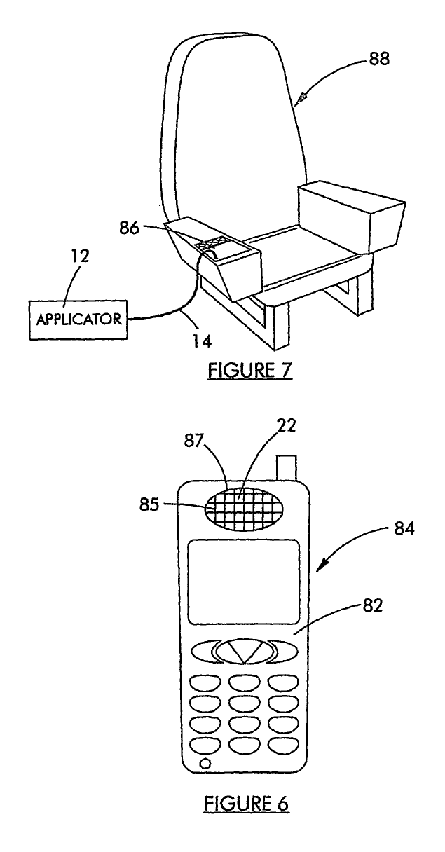

FIG. 6 is a block diagram of a fourth embodiment of the apparatus according to the invention; and

FIG. 7 is a diagram illustrating a fifth embodiment of the apparatus according to the invention.

### DESCRIPTION OF A PREFERRED EMBODIMENT OF THE INVENTION

An apparatus for treating pain in a mammal is shown in FIGS. 1 and 2. The apparatus comprises a main housing 10 for an electrical signal generator and a separate audible signal applicator 12 connectable to the housing by a suitable lead 14. The electrical signal is converted to an audible signal and the audible signal is applied to the body (not shown) of a mammal, such as a human (hereinafter referred to as the patient), to treat pain, sinus problems and other ailments or problems, as will hereinafter be described.

The main housing is typically a table or desktop unit and has a front control panel 16 comprising a display 18 and a keypad 20. The applicator 12 is a hand held unit and houses an electrical signal to audible signal transducer, such as a diaphragm loudspeaker 22. The loudspeaker is mounted in a peripheral region of the applicator so that, in use,it may be brought Into very close proximity with the skin of the patient under treatment.

The electrical signal generator is shown in more detail at 24 in FIG. 3. The generator 24 comprises a conventional power supply 26, which is connectable to mains electrical power. The power supply is further connected to a back-up battery 28 in well-known manner. The power supply is connected via ON/OFF switch 30 on the keypad 20 to the remainder of the generator circuitry. The generator further comprises a known micro-controller 32 in the form of a PIC 16F876. The controller is connected to the power supply as well as to the control panel 16 via data bus 34. One output 36 of the controller Is connected to a signal amplifier and conditioner 38 to produce at an output 40 thereof a sine wave of a required frequency. The output 40 is connected via lead 14 to the loudspeaker 22 in the hand-held applicator 12. The level of the audible signal is less than 100 dBA at the diaphragm, preferably between 50 dBA and 80 dBA and even more preferably between 60 dBA and 70 dBA. The frequency of the signal is between 50 Hz and 1000 Hz, preferably between 70 Hz and 160 Hz, as will hereinafter be described.

The apparatus further comprises a heart rate monitoring probe 42. The probe 42 comprises a photo device comprising a light emitting diode 44 for transmitting a photo signal to a phototransistor 46. The probe defines a passage 47 for receiving a finger 48 of the patient. The light transmitted is modulated by blood being pumped through the finger in accordance with the heartbeat and hence heart rate of the patient. An output of the transistor is connected via a lead 49 to a signal amplifier and conditioner 50 and the output of the amplifier is connected to the aforementioned controller 32. The resulting signal is processed by the controller and data relating to the measured heart rate is forwarded via bus 34 for display on the display 18.

The keypad 20 comprises a number of push buttons, including the aforementioned ON/OFF button 30. Each button comprises an associated signal lamp which, in use, is caused to be energized by the controller, to signal to or prompt the user. These buttons with integral lamps are designated 52 to 68 in FIGS. 1 and 3.

The aforementioned audible signals are used to provide sinus drainage or to relieve pain in the patient and a prototype of the apparatus would work as follows. When the apparatus is switched on, lamps 54 and 60 are pulsed to prompt the user to select one of pain treatment or sinus treatment respectively. If sinus treatment is selected, the generator generates a sinusoidal signal at 150 Hz. The user presses the start button 68 and the loudspeaker generates an audible tone at 150 Hz. The user applies the audible signal by means of applicator 12 to suitable positions on the face of the patient. The treatment cycle is five minutes in duration.

If pain treatment is selected by actuation of button 54, lamps 56 and 58 are energized to prompt the user to select one of acute pain treatment or chronic pain treatment, by actuating the relevant associated button 56 or 58. In both cases and after selection, the user is prompted to select one of joint pain treatment, muscle pain treatment and other pain treatment by actuating button 62 or 64 or 66. Depending on the selection, one of the following cycles of signal phases Is generated, after the start button 68 has been actuated:

| | Other Pain | | Muscle Pain | | Joint Pain | | Time Per Phase | |
|---|---|---|---|---|---|---|---|---|
| 1^{st} phase | 160.0 | Hz | 121.25 | Hz | 82.4 | Hz | 2 | mins |
| 2^{nd} phase | 153.15 | Hz | 110.0 | Hz | 81.0 | Hz | 1 | min |
| 3^{rd} phase | 146.90 | Hz | 96.25 | Hz | 76.97 | Hz | 1 | min |
| 4^{th} phase | 130.80 | Hz | 87.3 | Hz | 70.00 | Hz | 1 | min |

Hence, for joint pain, a first phase signal of 82.4 Hz is generated for 2 minutes, thereafter and automatically, a second phase signal of 81 Hz is generated, thereafter a third phase signal of 76.97 Hz is generated and thereafter a fourth phase signal of 70 Hz is generated. The total duration of the cycle is 5 minutes. In the case of treatment of acute pain the treatment is stopped at the end of the cycle. To repeat, the full aforementioned procedure must be repeated. In the case of treatment of chronic pain, the cycle is repeated by mere actuation of the start button 68, at the end of a cycle.

In use, the lamp 52 prompts the user to apply the heart rate probe 42. Upon actuation of button 52, the controller 32 causes the heart rate as measured to be displayed on the display 18. Relief experienced by a patient is normally accompanied by a decrease in heart rate. Furthermore, a decrease in heart rate may also be utilized by the controller 32 automatically to change to a next phase in a treatment cycle.

In an embodiment shown in FIG. 4, the electrical signal generator may form part of a computing device 70 such as a personal computer in the form of a desk top computer, a lap top computer a palm device or any other computing device. The device may hence be connectable to other devices via any suitable data network 72, such as the Internet. Data relating to the electrical signal to be generated may be downloaded into the computing device via the network. A website 74 with treatment data and other information may also be provided.

In an embodiment shown In FIG. 5, the electrical signal generator may form part of a decoder 76 for receiving encoded broadcast services, such as encoded television services. In this embodiment data relating to the signals to be generated may be transmitted to the decoder from a head end 78 via satellite 80, for example.

In still another embodiment shown in FIG. 6, the generator may be integrated in a housing 82 of a cellular phone instrument 84. In this embodiment data relating to the signals to be generated may be downloaded into a memory arrangement of the cellular phone, via the cellular phone infrastructure. A spacer 85 may be provided between the loudspeaker 22 and an output port 87 for the audible signal

In still other embodiments, the applicator 12 may also be made available to passengers in an airliner. As shown in FIG. 7, the applicator 12 may be connectable to the known console 86 with control panel for sound and cinematograph services at each seat 88 in the plane.

In still other embodiments, the applicator 12 may be integrated in a wristwatch.

1. Apparatus for relieving pain in a body of a mammal, the apparatus comprising:
a generator for an audible signal having a level at a source of the signal of smaller than 100 dBA and having a frequency between 50 Hz and 1000 Hz; and
an applicator for applying the audible signal to the body of the mammal.

2. Apparatus as claimed in claim 1 wherein the level is between 50 dBA and 80 dBa.

3. Apparatus as claimed in claim 2 wherein the level is between 60 dBA and 70 dBA.

4. Apparatus as claimed in any one of claims 1-3 wherein the frequency is between 70 Hz and 160 Hz.

5. Apparatus as claimed in claim 1 wherein the audible signal is entrained in accompanying music.

6. Apparatus as claimed in claim 1 wherein the generator comprises an electrical signal generator and a sound transducer.

7. Apparatus as claimed in claim 6 wherein the sound transducer comprises a loudspeaker.

8. Apparatus as claimed in claim 6 wherein the electrical signal is a sinusoidal signal.

9. Apparatus as claimed in any one of claims 6 to 8 wherein the electrical signal generator is housed in a main housing and the applicator comprises a separate housing for the transducer and which is connectable to the main housing by a suitable link.

10. Apparatus as claimed in any one of claims 6 to 8 wherein the electrical signal generator and transducer are both housed in a common hand held housing.

11. Apparatus as claimed in claim 6 wherein the transducer is located in a peripheral region of the applicator, so that, in use, it can be held in close proximity with the skin of the patient.

12. Apparatus as claimed in claim 6 wherein a spacer is provided between the transducer and an outlet port for the audible signal.

13. Apparatus as claimed in claim 6 wherein the electrical signal generator comprises a computing device.

14. Apparatus as claimed in claim 13 wherein data relating to the electrical signal to be generated is downloadable into the computing device via a communications network.

15. Apparatus as claimed in claim 14 wherein the data is downloadable form a website accessible via the network.

16. Apparatus as claimed in claim 6 wherein the electrical signal generator forms part of a decoder for receiving encoded broadcast services.

17. Apparatus as claimed in claim 1 wherein the applicator is housed in a housing of a cellular phone instrument.

18. Apparatus as claimed in claim 1 wherein the applicator is connectible to a console at a seat in an airplane.

19. Apparatus as claimed in claim 1 wherein the applicator is integrated in a wristwatch.
